(19) United States
(12) Patent Application Publication
(10) Pub. No.: US 2008/0123251 A1
(43) Pub. Date: May 29, 2008

(54) Capacitor device

(76) Inventors: Michael S. Randall, Simpsonville, SC (US); Peter Blais, Milford, MA (US); Pascal Pinceloup, Simpsonville, SC (US); Daniel J. Skamser, Simpsonville, SC (US); Abhijit Gurav, Greenville, SC (US); Azizuddin Tajuddin, Laurens, SC (US); John T. Kinard, Greer, SC (US); Philip Lessner, Newberry, SC (US)

Correspondence Address: NEXSEN PRUET, LLC, P.O. BOX 10648, GREENVILLE, SC, 29603, US

(21) Appl. No.: 11/605,160

(22) Filed: Nov. 28, 2006

(51) Int. Cl. H01G 9/00

(52) U.S. Cl. 361/524; 29/25.03

(57) ABSTRACT

A process for forming a capacitive couple. The process includes forming a highly porous body of a conducting material with interior struts and voids in electrical contact. A dielectric layer is formed in the voids on the struts with a material having a dielectric constant above 100. An insulating layer is formed on the struts not covered by the dielectric layer. A conductive layer is formed on the dielectric layer and on the insulating layer.

### BACKGROUND OF THE INVENTION

The present invention is related to improvements in ceramic capacitive couples and devices comprising capacitive couples. More specifically, the present invention is related to a method for forming ceramic capacitive couples comprising dielectric in the interstitial spaces of a porous anode and a method for improving the capacitance achievable in a given volume by increasing the coverage of the interstitial spaces.

The growth in electronic components has continued for many decades. One of the ongoing efforts is the continued push towards miniaturization of electronic circuitry and the components contained therein. This effort is often contradictory to the companion desire to increase the capabilities of the electronic components. For many of the components it is difficult to achieve further miniaturization without sacrificing electrical performance. This is particularly the case with capacitors or components comprising capacitive couples. There has been an ongoing effort to increase capacitive density to support the overall miniaturization of electronic components.

The capacitor industry is dominated by multilayer ceramic capacitors and valve metal capacitors. Multilayer ceramic capacitors are characterized by alternating layers of electrode and ceramic wherein the ceramic is the dielectric between the electrodes. Valve metal capacitors typically include a plug of a valve metal with an oxide of the valve metal forming the dielectric. A conductive layer is then applied over the dielectric as the cathode coating. Furthering the capacitive density of either multilayer ceramic capacitors or valve metal capacitors is getting increasingly more difficult due to the extensive amount of effort already applied over many years by many researchers. While there may still be advances forthcoming, the effort required to achieve these advances is becoming more difficult and further improvements may be approaching a plateau.

Efforts have been undertaken to incorporate the dielectric, and cathode, into the interior of a porous anode. This approach has been described with polymeric cathodes in U.S. Pat. Nos. 6,987,663 and 6,361,572 for example. Barium and strontium titanate has been described as the internal dielectric in U.S. Pat. No. 5,790,368. It is difficult to effectively introduce the dielectric, or polymeric cathode material, into the interior of the porous anode. As a result the interior is not completely covered, which leads to shorts and high leakage current in capacitors of this nature. Utilization of this technique has not been considered feasible on a large scale due to the high level of losses which occur with incomplete coverage of the interior of the porous anode body.

There is an industry wide need to transition from multilayer ceramic and valve metal capacitive structures towards a capacitive structure which can achieve higher capacitance volume than either current technique is expected to reasonably achieve. The present invention provides a novel structure and method of achieving such a structure.

### SUMMARY OF THE INVENTION

It is an object of the present invention to provide a capacitive couple with a higher capacitive density and capacitors formed therewith.

It is another object of the present invention to provide a capacitive couple with the interior areas of the anode covered by ceramic dielectric and a method for insuring complete coverage of the interior.

It is another object of the present invention to provide a capacitive couple comprising a porous anode from a conductor such as a valve metal with a sufficient covering of dielectric on the interior surface of the porous body to eliminate electrical shorts and leakage current.

A particular feature of the present invention is the increase in capacitance as a function of volume without loss of electrical properties.

These and other advantages, as will be realized, are provided in a process for forming a capacitive couple. The process includes forming a highly porous conductive body, such as a valve metal, with interior struts and voids having a connective wire in electrical contact with the highly porous conductive body and extending beyond the highly porous body. A dielectric layer is formed in the voids on the struts with a material having a dielectric constant above 100. An insulating layer is formed on the struts not covered by the dielectric layer. A conductive layer is formed on the dielectric layer and on the insulating layer. The connective wire is connected to a first lead and a second lead is connected to the conductive layer.

Yet another embodiment is provided in a process for forming a capacitive couple. The process includes forming a porous body with at least one material selected from a valve metal, a valve metal alloy, a conductive valve metal oxide, valve metal nitride and valve metal carbide with interior struts and voids. A dielectric layer is formed in the voids on the struts with a material having a dielectric constant above 100. An insulating layer is formed on the struts not covered by the dielectric layer. A conductive layer is formed on the dielectric layer and on the insulating layer.

Yet another embodiment is provided in a capacitive element. The capacitive element has a porous conductor, such as a valve metal, anode with struts and voids between the struts. A first dielectric is in the voids coated on the struts wherein the first dielectric has a dielectric constant of at least 100. A second dielectric is in the voids and coated on the struts at locations where the first dielectric does not coat the struts. A conductive layer is in the voids and coating the first dielectric and the second dielectric. External termination is in electrical contact with the porous anode and second external termination is in electrical contact with the conductive layer.

### BRIEF SUMMARY OF THE DRAWINGS

FIG. 1 is a partial cross-sectional view of a capacitor of the present invention.

FIG. 2 is a close-up view of a portion of the anode of FIG. 1.

FIG. 3 is a flow chart illustrating a preferred process of the present invention.

FIG. 4 is a schematic representation of an embodiment of the present invention.

FIG. 5 is a schematic representation of an embodiment of the present invention.

### DETAILED DESCRIPTION OF THE INVENTION

The invention will be described with reference to the figures forming an integral part of the instant application.

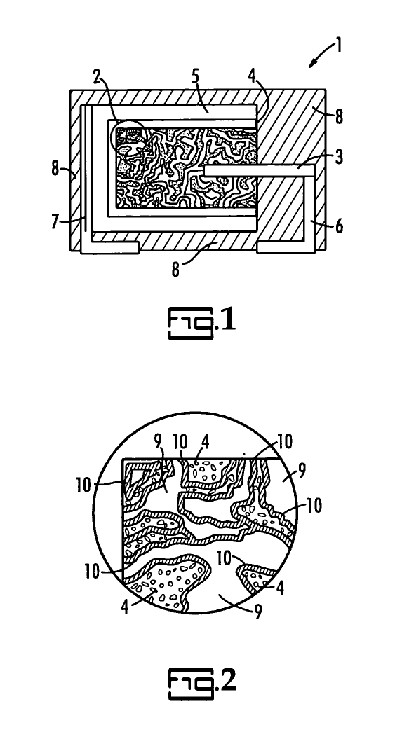

A capacitor of the present invention is illustrated in cross-sectional view in FIG. 1. In FIG. 1, the capacitor, generally represented at 1, comprises a porous anode, 2, with dielectric in the pores of the anode which are not visible in this view. An anode lead wire, 3, extends from the anode and is in electrical contact with the anode. The anode lead wire is typically pressed into the anode or welded to the anode. A cathode layer, 4, extends from the interior of the anode to the exterior as will be more readily understood from the description infra. The anode, dielectric and cathode form a capacitive couple which can be incorporated into a device such as a capacitor. An adhesive layer, 5, allows the cathode to be electrically connected to a cathode lead, 7. The adhesive layer may include multiple layers to allow adequate adhesion and conductivity from the cathode layer to the cathode lead. The adhesive layer may include a carbon layer, a silver layer, a gold layer and the like or combinations thereof. An anode lead, 6, is in electrical contact with the anode wire, 3, to provide electrical connectivity to the exterior of the capacitor as known in the art. In one embodiment the entire capacitive couple and connectivity to external leads is encased in a non-conductive resin, 8, thereby forming a capacitor.

The capacitor illustrated in FIG. 1 is typically referred to as a discrete capacitor. It would be readily understood to one of skill in the art that the present invention would also be suitable for any environment typically employing capacitive couples. The capacitive couple may be discrete or incorporated into a substrate, it may be integral to a substrate, or attached to a substrate directly without the necessity of anode and cathode leads.

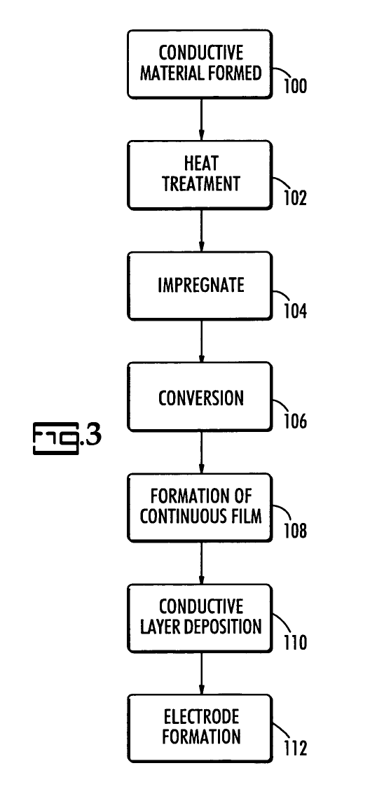

A close-up view of the anode of FIG. 1 is illustrated in FIG. 2. In FIG. 2 the porous anode body comprises struts, 9, within the interior of the porous body. The struts comprise the conductor, which is preferably a valve metal, and between the struts are areas which are void of the conductor. Prior to further treatment of the porous anode the appearance is that of a sponge with tortuous paths through the porous body and with interconnected struts extending there through and substantially forming an electrical network of struts throughout the porous anode body. On the interior surface of the struts is a dielectric the application of which will be described with more detail infra. On the interior surfaces of the dielectric, 10, and extending to the exterior is a conductive layer, 4. The anode and conductive layer, with a dielectric there between, forms the capacitive couple.

The process for forming the inventive capacitor is described with reference to FIG. 3. In FIG. 3, a suitable conductive material is formed, 100, into a highly porous body with open porosity. The porous body is formed by any acceptable method suitable for forming such a body including pressing, slip casting, extrusion, tape casting, centrifugal casting, etching and thick film printing methods such as screen printing, gravure printing, flexographic printing, ink jet printing and stencil printing. The porosity is preferably at least 10% to no more than 95% by volume. The porous body can be formed with electrical conductivity integral thereto, such as by pressing an electrode wire in the porous body, or the porous body can be adapted to be in electrical contact with an electrode or other means of electrical conductivity such as welding and the like. The porous body substrate is preferably a valve metal, more preferably selected from tantalum, niobium, niobium oxide or aluminum. Inert metals such as tungsten, molybdenum, or copper may be employed as may highly inert metals such as silver, palladium, platinum and gold. It is preferred that the valve metal powders have a charge-mass ratio of at least 20,000 μC/g with the higher ratios being most preferred. It is more preferred that the valve metal powders have a charge-mass ratio of at least 60,000 μC/g with at least 140,000 μC/g being most preferred.

The formed porous body is optionally heat treated, at 102, to achieve a substrate microstructure with adequate strength. Care must be taken during the heating operation to maintain as much surface area and open porosity as possible. In cases were the porous body is a foil formed by etching, or similar techniques, the heating may not be necessary. The heating step is primarily stage 2 sintering at a temperature of about 900 to 1,700° C. since this achieves the desired mechanical strength without compromising the microstructure or porosity.

The porous body is impregnated with a high dielectric constant material, or precursor material at 104. The dielectric material has a dielectric constant typically above 100 and is preferably a ferroelectric or relaxor material or a combination thereof. Particularly preferred dielectric materials comprises at least 60 wt % of at least one of barium titanate, barium strontium titanate, strontium titanate, barium neodymium titanate, barium zirconium titanate, lead titanate, lead zirconium titanate, lead magnesium niobate, lead zinc niobate, or precursors thereof. The dielectric may also be doped as is typical in the art. The method of impregnation is selected based on the desire to coat as much of the surface area of the internal struts of the microstructure as possible. The method of impregnation is preferably selected from dipping, wicking, vacuum impregnation, spin coating, centrifugal coating, spraying, pressure coating, pressure impregnation, freeze drying, chemical vapor deposition and electrophoretic deposition. The dielectric may be preformed and deposited or it may be formed in situ by impregnating the porous substrate with components which are then treated to react to form the dielectric. As would be realized the dielectric is impregnated as a component of a carrier matrix comprising solvents, rheology modifiers, wetting adjuvants, counter ions and the like. After impregnation the carrier solution, comprising dielectric or dielectric precursor must be converted to remove all non-ceramic components of the carrier matrix. The carrier matrix may contain a ceramic or the carrier matrix may contain precursors materials, such as salts, which form the ceramic upon heating.

The dielectric, or dielectric precursor, is then converted, at 106, to form a dense, semi-continuous insulating dielectric film on the internal struts of the porous substrate microstructure. Conversion removes all solvents, rheology modifiers, wetting adjuvants, counter ions and the like and, if necessary, sintering the ceramic or ceramic precursors to form the ceramic leaving only a dielectric ceramic coated on the interior struts of the porous anode body. The method of conversion is not particularly limiting. Particularly preferred methods of conversion include drying, firing and sintering by rapid thermal annealing, vacuum firing, microwave heat treatment or induction heating. The conversion can be done under ambient atmosphere, under reduced pressure, in a reducing or partially reducing atmosphere or in neutral atmosphere.

After conversion it is preferred that the dielectric layer have a thickness of at least 0.5 nm to no more than 2000 nm. The deposition and conversion may need to be repeated as necessary to achieve an adequate thickness and dielectric coverage. The dielectric layer may be a particulate coating, a dense film or coating, an interconnected lacy film or coating or have localized coverage such as with islands.

The dielectric layer is then completed by formation of a continuous dielectric insulating film at 108 with a dielectric having a dielectric constant of less than about 100. The continuous insulating film removes any shorts or high leakage areas remaining after the conversion. The completion can be accomplished by anodization, thermal oxidation, or a secondary impregnation. The insulating material is preferably introduced into the voids by dipping, wicking, vacuum impregnation, spin coating, centrifugal coating, spraying, pressure coating, pressure impregnation, freeze drying, chemical vapor deposition, electrophoretic deposition or similar processes. The thickness of the insulating layer is preferably at least about 0.5 nm to no more than about 5000 nm. More preferably the thickness of the insulating layer is no more than about 3000 nm. The completion step is a necessity owing to the incomplete coverage of the interior struts of the porous substrate during the impregnation of high dielectric constant materials. In standard manufacturing processes it is preferred to add a continuous insulating film to increase the manufacturing yields resulting from some, albeit small, percentage of incomplete dielectric layers. It is preferred to minimize the coverage of the insulating film as the relative dielectric constant is low compared to the resultant dielectric insulating film previously deposited.

A conductive layer is deposited over the dielectric or insulating layer at 110. The conductive layer preferably comprises at least one of manganese dioxide, conductive polymer, organometallic, organometallic with metallic fillers, metallic glass, a metal or a metal powder in a suspension or a precursor thereof. The conductive layer may be deposited as a conductor or a conductive precursor can be deposited and converted. Silver nitrate, for example, may be coated after which the silver is reduced to elemental silver. The conductive layer is preferably 1 nm to 10⁶ nm thick. The thickness is chosen to insure adequate coverage and electrical conductivity, increased thickness beyond that goal is of no benefit. The conductive film may require a post treatment to insure a conductive continuous film. The post treatment may include, but is not limited to, thermal treatment in ambient atmosphere, at a reduced pressure, or in an environment which is reducing, partially reducing or neutral. In a particularly preferred embodiment the conductive layer is self healing such as is the case with manganese dioxide to further improve insulation resistance to the device. A post cathode anodization, and/or reformation, may be used to further reduce leakage current.

The conductive polymer preferably comprises a heterocyclic five or six-membered ring compound. Non-limiting examples include pyrrole, thiophene, 3-alkylthiophene, isocyanaphthene, polyparaphenylene, polyaniline and polyparaphenylenevinylene. Doped polymers may be utilized but inherently conductive polymers are preferred. Particularly preferred conductive polymers include polyethylenedioxythiophene and derivatives thereof.

After formation of the conductive layer electrodes are formed, at 112, wherein one is in electrical contact with the conductive layer, typically referred to as the cathode, and the other is in electrical contact with the substrate material. The electrodes may be formed by traditional lead frame techniques or may be formed by deposition of conductive carbon thick film followed by silver paint and attachment of an external lead via conductive epoxy or the like. The electrodes form an electrical path from the interior to the exterior thereby forming a capacitor structure.

The capacitor is typically tested, burned-in and packaged as known in the art.

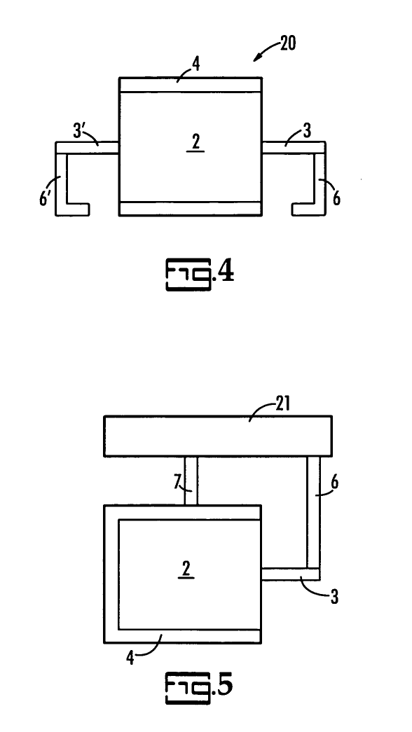

An embodiment of the present invention is illustrated in FIG. 4. In FIG. 4 the capacitive couple is formed by a porous anode, 2, which is impregnated with a dielectric and insulator layer as described supra, and a conductive layer, 4. A multiplicity of anode wires, 3 and 3′, extend from the anode and are in electrical contact with anode leads, 6 and 6′. The cathode layer, 4, and anode leads, 3 and 3′, can be directly mounted to a substrate to form a electromagnetic interference filter, 20, as known in the art.

Another embodiment of the present invention is illustrated in FIG. 5. In FIG. 5, the capacitive couple is formed by a porous anode, 2, which is impregnated with a dielectric and insulator layer as described supra, and a conductive layer, 4. The anode wire, 3, can be electrically connected through an anode lead, 6, to a second electrical component, 21. Likewise, the cathode, 4, can be electrically connected through a cathode lead, 7, to a second device. The second electrical component can be a circuit, a circuit trace, another capacitor to form ganged capacitors, or another electrical component which can be coupled with a capacitor to function in an electrical capacity.

Current conventional valve metal capacitive couples, for example with tantalum or niobium, may utilize about 150,000 μFV/gram materials, formed to a voltage of about 3 times the rated voltage (RV) with an associated dielectric constant of less than about 50 resulting in a dielectric thickness of about 2 to 2.5 nm per volt. Utilizing a dielectric constant of the dielectrics above about 1000 or greater and a 30 nm dielectric thickness with 100% high K dielectric coverage would be expected to achieve a capacitance increase of from 100 μF to about 2000 μF. or more. The achievable capacitance would decrease with increasing dielectric thickness. Doubling the dielectric thickness would reduce the achievable capacitance by a factor of about 2. With the present invention a continuous high K dielectric with a thickness of about 267 nm would be expected to provide a capacitance of about 227 or more than double the currently available capacitance for tantalum capacitors assuming full coverage of high K dielectric. With less than full coverage, the composite K of the high K and low K dielectric film would be expected to follow the perpendicular mixing rule. With 50% coverage at 30 nm thickness of the low K dielectric and a 267 nm dielectric thickness of high K dielectric the capacitance is expected to be about 167 which is still about 60% higher than current tantalum capacitors. The present invention can provide a significant increase in capacitance relative to current capacitors at approximately the same size.

The invention has been described with particular emphasis on the preferred embodiments. One of skill in the art would readily realize additional embodiments and alterations based on the description herein without departure from the scope of the invention which is more specifically set forth in the claims appended hereto.

Claimed is:

1. A process for forming a capacitive couple comprising:
forming a porous body of a conductive material comprising interior struts and voids;
forming a dielectric layer in said voids on said struts with a material having a dielectric constant above 100;
forming an insulating layer on said struts not covered by said dielectric layer; and
forming a conductive layer on said dielectric layer and on said insulating layer.

2. The process for forming a capacitive couple of claim 1 further comprising a connective wire in electrical contact with said conductive material and extending beyond said porous body.

3. The process for forming a capacitive couple of claim 1 wherein said highly porous body has a porosity of at least 10% to no more than 95% by volume.

4. The process for forming a capacitive couple of claim 1 wherein said dielectric layer comprises 60 wt % of at least one of barium titanate, barium strontium titanate, strontium titanate, barium neodymium titanate, barium zirconium titanate, lead titanate, lead zirconium titanate, lead magnesium niobate, lead zinc niobate, or precursors thereof.

5. The process for forming a capacitive couple of claim 1 wherein said forming a dielectric layer comprises:
impregnating said highly porous body with a carrier matrix comprising dielectric or dielectric precursors.

6. The process for forming a capacitive couple of claim 1 wherein said forming a dielectric layer comprises impregnating said voids with a dielectric or a dielectric precursor by a method selected form dipping, wicking, vacuum impregnation, spin coating, centrifugal coating, spraying, pressure coating, pressure impregnation, freeze drying, chemical vapor deposition and electrophoretic deposition.

7. The process for forming a capacitive couple of claim 6 further comprising converting said carrier matrix comprising dielectric or dielectric precursors to a dielectric layer.

8. The process for forming a capacitive couple of claim 1 wherein said dielectric layer has a thickness of at least 0.5 nm to no more than 2000 nm.

9. The process for forming a capacitive couple of claim 1 wherein said insulating layer is formed by anodization.

10. The process for forming a capacitive couple of claim 1 wherein said insulating layer is formed by impregnating said voids with an insulator or insulator precursor by a method selected from dipping, wicking, vacuum impregnation, spin coating, centrifugal coating, spraying, pressure coating, pressure impregnation, freeze drying, chemical vapor deposition, thermal oxidation and electrophoretic deposition.

11. The process for forming a capacitive couple of claim 1 wherein said insulating layer has a thickness of 0.5 nm to 3000 nm.

12. The process for forming a capacitive couple of claim 1 wherein conductive layer comprises at least one of manganese dioxide, conductive polymer, organometallic, glassy metal, organometallic with metal fillers, or metal.

13. The process for forming a capacitive couple of claim 1 wherein said conductive layer has a thickness of 1 nm to 10⁶ nm.

14. The process for forming a capacitive couple of claim 1 wherein said conductive material is selected from tantalum, titanium, tungsten, molybdenum, niobium, niobium oxide, copper, silver, palladium, platinum, gold and aluminum.

15. The process for forming a capacitive couple of claim 1 further comprising encapsulating said capacitive couple.

16. The process for forming a capacitive couple of claim 1 further comprising incorporating said capacitive couple in an electrical or electronic component.

17. The process for forming a capacitive couple of claim 1 further comprising incorporating said capacitive couple in an electromagnetic interference filter.

18. A process for forming a capacitive couple comprising:
forming a porous body comprising at least one material selected from a valve metal, a valve metal alloy, a conductive valve metal oxide, valve metal nitride and valve metal carbide comprising interior struts and voids;
forming a dielectric layer in said voids on said struts with a material having a dielectric constant above 100;
forming an insulating layer on said struts not covered by said dielectric layer; and
forming a conductive layer on said dielectric layer and on said insulating layer.

19. The process for forming a capacitive couple of claim 18 further comprising a connective wire in electrical contact with said material and extending beyond said porous body.

20. The process for forming a capacitive couple of claim 18 wherein said highly porous body has a porosity of at least 10% to no more than 95% by volume.

21. The process for forming a capacitive couple of claim 18 wherein said dielectric layer comprises 60 wt % of at least one of barium titanate, barium strontium titanate, strontium titanate, barium neodymium titanate, barium zirconium titanate, lead titanate, lead zirconium titanate, lead magnesium niobate, lead zinc niobate, or precursors thereof.

22. The process for forming a capacitive couple of claim 18 wherein said forming a dielectric layer comprises:
impregnating said highly porous body with a carrier matrix comprising dielectric or dielectric precursors.

23. The process for forming a capacitive couple of claim 18 wherein said forming a dielectric layer comprises impregnating said voids with a dielectric or a dielectric precursor by a method selected form dipping, wicking, vacuum impregnation, spin coating, centrifugal coating, spraying, pressure coating, pressure impregnation, freeze drying, chemical vapor deposition and electrophoretic deposition.

24. The process for forming a capacitive couple of claim 23 further comprising converting said carrier matrix comprising dielectric or dielectric precursors to a dielectric layer.

25. The process for forming a capacitive couple of claim 18 wherein said dielectric layer has a thickness of at least 0.5 nm to no more than 2000 nm.

26. The process for forming a capacitive couple of claim 18 wherein said insulating layer is formed by anodization.

27. The process for forming a capacitive couple of claim 18 wherein said insulating layer is formed by impregnating said voids with an insulator or insulator precursor by a method selected from dipping, wicking, vacuum impregnation, spin coating, centrifugal coating, spraying, pressure coating, pressure impregnation, freeze drying, chemical vapor deposition, thermal oxidation and electrophoretic deposition.

28. The process for forming a capacitive couple of claim 18 wherein said insulating layer has a thickness of 0.5 nm to 3000 nm.

29. The process for forming a capacitive couple of claim 18 wherein conductive layer comprises at least one of manganese dioxide, conductive polymer, organometallic, glassy metal, organometallic with metal fillers, or metal.

30. The process for forming a capacitive couple of claim 18 wherein said conductive layer has a thickness of 1 nm to 10⁶ nm.

31. The process for forming a capacitive couple of claim 18 wherein said material comprises at least one material selected from tantalum, titanium, tungsten, molybdenum, niobium, niobium oxide, and aluminum.

32. The process for forming a capacitive couple of claim 18 further comprising encapsulating said capacitive couple.

33. The process for forming a capacitive couple of claim 18 further comprising incorporating said capacitive couple in an electrical component.

34. The process for forming a capacitive couple of claim 18 further comprising incorporating said capacitive couple in an electromagnetic interference filter.

35. A capacitive element comprising:
a porous conductor material comprising struts and voids between said struts;
a first dielectric in said voids coated primarily on said struts wherein said first dielectric has a dielectric constant of at least 100;
a second dielectric in said voids coated on said struts at locations where said first dielectric does not coat said struts;
a conductive layer in said voids coating said first dielectric and said second dielectric;
external termination in electrical contact with said porous body; and
external termination in electrical contact with said conductive layer.

36. The capacitive element of claim 35 wherein said porous material comprises at least one element selected from tantalum, titanium, tungsten, molybdenum, niobium, niobium oxide, copper, silver, palladium, platinum, gold and aluminum.

37. The capacitive element of claim 35 wherein said dielectric layer comprises 60 wt % of at least one of barium titanate, barium strontium titanate, strontium titanate, barium neodymium titanate, barium zirconium titanate, lead titanate, lead zirconium titanate, lead magnesium niobate, lead zinc niobate, or precursors thereof.

38. The capacitive element of claim 35 wherein said dielectric layer has a thickness of at least 0.5 nm to no more than 2000 nm.

39. The capacitive element of claim 35 wherein said insulating layer has a thickness of 0.5 nm to 3000 nm.

40. The capacitive element of claim 35 wherein conductive layer comprises at least one of manganese dioxide, conductive polymer, organometallic, glassy metal, organometallic with metal fillers, or metal.

41. The capacitive element of claim 35 wherein said conductive layer has a thickness of 1 nm to 10⁶ nm.

42. The capacitive element of claim 35 wherein said highly porous body has a porosity of at least 10% to no more than 95% by volume.

43. The capacitive element of claim 35 wherein at least one of said first dielectric and said second dielectric is formed by impregnating said voids with an insulator or insulator precursor by a method selected from dipping, wicking, vacuum impregnation, spin coating, centrifugal coating, spraying, pressure coating, pressure impregnation, freeze drying, chemical vapor deposition, thermal oxidation, gaseous reaction and electrophoretic deposition.
